(19) United States
(12) Patent Application Publication
(10) Pub. No.: US 2017/0095988 A1
(43) Pub. Date: Apr. 6, 2017

(54) C-FRAME PRESS

(71) Applicant: MODUS ONE GMBH, ASPERG (DE)

(72) Inventor: Joerg RAUSCHENBERGER, ASPERG (DE)

(21) Appl. No.: 15/382,780

(22) Filed: Dec. 19, 2016

Related U.S. Application Data
(63) Continuation of application No. PCT/EP2015/064601, filed on Jun. 26, 2015.

(30) Foreign Application Priority Data
Jun. 30, 2014 (DE) 10 2014 109 144.2

(51) Int. Cl. B30B 15/04; B30B 15/00; B30B 1/16

(52) U.S. Cl. CPC B30B 15/047; B30B 15/041; B30B 1/16; B30B 15/007; B30B 15/0035

(57) ABSTRACT

A C-frame press having a press frame, a first ram device, an opposed second ram device, and a drive device for moving at least one of the ram devices in a pressing direction. The press frame has first and second bending bars connected to each other by a tension column and a pressure column which together define a frame plane extending parallel to the pressing direction. The tension column is connected to each of the first and second bending bars by a bearing which is torque-free about an axis which extends perpendicularly to the frame plane. The first and second ram devices are each supported on the press frame by a bearing which is torque-free about an axis which extends perpendicularly to the frame plane. At least the at least one movable ram device is guided in a linear guide which extends parallel to the pressing direction.

### CROSS-REFERENCE TO RELATED APPLICATIONS

This application is a Continuation application of International application PCT/EP2015/064601, filed Jun. 26, 2015, which claims the priority of German patent application DE 10 2014 109 144.2, filed Jun. 30, 2014. The entire contents of these prior applications are incorporated herein by reference.

### BACKGROUND OF THE INVENTION

The present invention relates to a C-frame press having a press frame, a first ram device and a second ram device which is opposite the first ram device, wherein at least one of the first ram device and second ram device has at least one drive device and can be moved relative to the other ram device in a pressing direction.

C-frame presses are generally known in the prior art. They are used to process workpieces, in particular to stamp, cut or cold-form workpieces. Those workpieces are generally arranged on a so-called “table”. A ram which carries a specific processing tool for processing the workpiece is movable relative to this table. The region between the table and the ram is accessible from three sides in the case of a C-frame press. This results from the table and the ram being carried by a frame or housing which is substantially C-shaped in cross-section, from which the name of this type of press is derived.

In the prior art the fixed support or rest of the workpiece is generally referred to as a “table”. The moved counter-element which applies the pressing force is generally referred to as a “ram”. However, those terms have now been expanded in that tables may certainly be movable and sometimes also apply a pressing force to the workpiece via drive devices at least partially. In the context of this application, therefore, the more generalized term “ram device” will be used. This includes both movable ram devices which are driven by means of a drive device and which apply a pressing force and which are also referred to below as “active rams”. However, the term “ram device” also includes table elements which have freedom of movement in at least one spatial direction, for example, because they are guided in a linear guide but they do not apply any pressing force. They are also referred to below as “passive rams”.

Such C-frame presses are particularly suitable for manual inlay operations as a result of the described free accessibility from three sides but also for automated processing operations by punching from a strip, follow-on composite tools or sets of steps with transfer devices. Such C-frame presses can be used in particular during processing of sheet metal and massive products, in this instance particularly for processing operations such as cutting, drawing, bending and stamping, and for additional processing operations, such as, for example, joining and connecting.

However, such C-frame presses also have disadvantages. It is known that the C-frame which is open at three sides bends open under load in an asymmetrical manner. This is explained below briefly with reference to FIG. 1 which shows a C-frame press according to the prior art.

FIG. 1 illustrates a C-frame press 1 which is known from the prior art and which has a ram 2 and a table 3. The ram 2 and table 3 are fitted in a C-frame 6. The C-frame has the characteristic C-shape which can be seen in FIG. 1. The ram 2 can be lowered onto the table 3 by means of a drive device which is not illustrated in order to apply a pressing force to a workpiece which is intended to be arranged between the table 3 and the ram 2. In this case, if the ram 2 is supported on the table 3 and the pressing force is applied, the C-frame press 1 becomes deformed, as schematically illustrated in FIG. 1. The surfaces of the ram 2 and the ram 3 then no longer extend parallel with each other and perpendicularly to a pressing direction 9 which extends vertically in a Y direction. Furthermore, there is produced a horizontal displacement of the tool halves which are fitted to the table 3 and the ram 2, that is to say, a displacement in an X direction. Furthermore, the bending open may be carried out in a completely asymmetrical manner, that is to say, the bending angle of the C-frame 4 and 4′″ at the ram surface 4′ and at the table surface 4″ may be of different amounts.

As a result of the bending open, consequently, an upper tool portion and a lower tool portion lose parallelism with each other. During a build-up of the pressing force, there is produced a horizontal displacement between the two tool halves. The resultant friction operations result in particular during punching operations in excessive wear of the driven elements and the guides or a premature breakage of tool elements.

For example, therefore, there is proposed in publication DE10 2012 102 526 A1 a press having a ram which can be moved by means of a press drive in a travel direction and having an angle table which has a guide member and a table member which is orientated at right-angles to the guide member, wherein the guide member has a guide device for guiding the ram in a travel direction and having a press frame on which the press drive is supported. The press frame is intended to have two frame elements which have a grid structure and which are each connected to the table member of the angular table, wherein the press frame can be moved relative to the guide member of the angular table and wherein the angular table has a base, via which the press can be deposited on a substrate and/or can be connected to the substrate.

For example, the publication DE 31 37 799 A1, publication DE 42 24 277 A1 and publication DE 100 28 346 A1 set out additional known C-frame presses.

However, C-frame presses still cannot be used for processing operations which place higher requirements on the precision and/or the wear, in particular, for example, punching operations with small tolerances or large batch numbers. Furthermore, the maximum pressing force of conventional C-frame presses is generally limited to a few thousand kN because otherwise the bending open also makes it impossible to carry out processing with lesser quality or requires over-dimensioning of the C-frames which is uneconomically great. A table depth is also generally limited, and therefore the maximum extent of a workpiece away from the C-frame, because, as a result of simple lever principles, the absolute dimension of the bending open becomes too large at one table end facing away from the C-frame.

Therefore, an object of the present invention is to provide a press with a C-frame construction type which prevents the above-described disadvantages while preserving the advantage of free accessibility from three sides.

### BRIEF SUMMARY OF THE INVENTION

According to one aspect of the invention, there is provided a C-frame press having a press frame, a first ram device and a second ram device which is opposite the first ram device, wherein at least one of the first ram device and second ram device has at least one drive device and can be moved relative to the other ram device in a pressing direction, wherein the press frame has a first bending bar and a second bending bar which are connected to each other by means of a tension column and a pressure column and which define with the tension column and pressure column a frame plane which extends parallel with the pressing direction, wherein the tension column is connected to each of the first bending bar and the second bending bar by means of a bearing which is torque-free about an axis which extends perpendicularly to the frame plane, wherein the first ram device and the second ram device are each supported on the press frame by means of a bearing which is torque-free about an axis which extends perpendicularly to the frame plane, and wherein the first ram device is guided in a linear guide which extends parallel with the pressing direction and/or the second ram device is guided in a linear guide which extends parallel with the pressing direction.

According to a further aspect of the invention, there is provided a C-frame press having a press frame, a first ram device and a second ram device which is opposite the first ram device, wherein at least one of the first ram device and second ram device has at least one drive device and can be moved relative to the other ram device in a pressing direction, wherein the press frame has a first bending bar and a second bending bar which are connected to each other by means of a tension column and a pressure column and which define with the tension column and pressure column a frame plane which extends parallel with the pressing direction, wherein the tension column is connected to each of the first bending bar and the second bending bar by means of a bearing which is torque-free about an axis which extends perpendicularly to the frame plane, wherein the first ram device and the second ram device are each supported in the press frame by means of a bearing which is torque-free about an axis which extends perpendicularly to the frame plane, and wherein the first ram device, in particular a ram of the first ram device, is guided in a linear guide which extends parallel with the pressing direction and wherein the second ram device, in particular a ram of the second ram device, is guided in a linear guide which extends parallel with the pressing direction.

According to a further aspect of the invention, there is provided a C-frame press having a press frame, a first ram device and a second ram device which is opposite the first ram device, wherein at least one of the first ram device and second ram device has at least one drive device and can be moved relative to the other ram device in a pressing direction, wherein the press frame has a first bending bar and a second bending bar which are connected to each other by means of a tension column and a pressure column and which define with the tension column and pressure column a frame plane which extends parallel with the pressing direction, wherein the tension column is connected to each of the first bending bar and the second bending bar by means of a bearing which is torque-free about an axis which extends perpendicularly to the frame plane, wherein the first ram device and the second ram device are each supported on the press frame by means of a bearing which is torque-free about an axis which extends perpendicularly to the frame plane, and wherein the first ram device is guided in a linear guide which extends parallel with the pressing direction.

According to a further aspect of the invention, there is provided a C-frame press having a press frame, a first ram device and a second ram device which is opposite the first ram device, wherein at least one of the first ram device and second ram device has at least one drive device and can be moved relative to the other ram device in a pressing direction, wherein the press frame has a first bending bar and a second bending bar which are connected to each other by means of a tension column and a pressure column and which define with the tension column and pressure column a frame plane which extends parallel with the pressing direction, wherein the tension column is connected to each of the first bending bar and the second bending bar by means of a bearing which is torque-free about an axis which extends perpendicularly to the frame plane, wherein the first ram device and the second ram device are each supported on the press frame by means of a bearing which is torque-free about an axis which extends perpendicularly to the frame plane, and wherein the second ram device is guided in a linear guide which extends parallel with the pressing direction.

Consequently, the press frame has a total of four functional elements. They are initially a first bending bar or upper bending bar and a second bending bar or lower bending bar. In place of the term “bending bar”, it is also possible to use here the term “frame element” or “frame member”. In mechanical terms, however, those elements fulfill the objective of a bending bar. The first and second bending bars are connected to each other by two column elements, the tension column and the pressure column. In this instance, the tension column is arranged so as to face the first ram device and the second ram device, that is to say, arranged adjacent to the ram devices. The pressure column is arranged at an end of the bending bars facing away from the ram devices. This then results in the terminology of those columns. When the pressing force is applied, the tension column is loaded in terms of tension and the pressure column is substantially loaded in terms of pressure. Furthermore, the pressure column serves to support forces perpendicular to the pressing direction, that is to say, in an operating position of the C-frame press in a horizontal direction.

The tension column, the pressure column and the two bending bars define a frame plane. A longitudinal axis of the tension column and a longitudinal axis of the pressure column may be in the frame plane and may define it. More specifically, the frame plane may be defined by the geometric center points of the tension column, the pressure column, the first bending bar and the second bending bar. In particular, but not necessarily, the first bending bar, the second bending bar, the tension column and/or the pressure column may have symmetry relative to the frame plane. The frame plane is then the plane of symmetry of the tension column, pressure column, first bending bar and/or second bending bar.

A “torque-free bearing” is in the terminology in engineering mechanics a bearing which transmits no torque or substantially no torque about a specific axis. Friction-related effects may be excepted. In this instance, this axis is an axis which extends perpendicularly to the frame plane. The tension column is connected both to the first and to the second bending bar by means of a bearing which is torque-free about an axis which extends perpendicularly to the frame plane. Such a torque-free axis may be provided, for example, by means of a rotary bearing. The term “about a bearing which is torque-free perpendicularly to the frame plane” may consequently also be replaced by “rotary bearing”. For example, a bolt which is guided through a recess in the tension column and the first or second bending bar may provide the torque-free bearing. No torques at all are then introduced into the tension column during the application of the pressing force via the first bending bar and the second bending bar. The tension column is consequently loaded only in terms of tension. As will be explained below in detail, in particular the tension column may have one or more linear guides for the first and/or the second ram device, in particular for the respective ram thereof. In principle, one or more linear guides for the first and/or the second ram device may also be provided separately from the tension column. This/these one or more linear guide(s) can then also be fitted to the first bending bar and/or the second bending bar or the press frame by means of a bearing which is torque-free about an axis which extends perpendicularly to the frame elements. At an end of such a linear guide, a longitudinal compensation member may then be provided, for example, in the form of a linear guide which is supported in a torque-free manner in the first bending bar and/or the second bending bar or the press frame.

The first ram device and the second ram device are also supported in the press frame by means of a bearing which is torque-free about an axis which extends perpendicularly to the frame plane.

Consequently, the tension column is connected to the two bending bars in such a manner that the bending bars do not introduce any bending stresses but only parallel tension stresses into the tension column in spite of a deformation which occurs when the pressing force is applied. The tension column consequently remains parallel with the pressing direction. The same applies to the linear guide which is either fitted to the tension column or is also supported in a torque-free manner in the bending bars. The ram devices are also supported in a torque-free manner in the bending bars. There are thereby prevented displacements of the active ram and the passive ram perpendicularly to the pressing direction or rotations of the active ram and the passive ram during the pressing operation. At the same time, a table which is rigidly connected to the press frame is not used, but instead a ram device which is also supported in a torque-free manner in the press frame and which is guided with a linear guide is used as a table. For example, the load is thus supported on the second ram device by means of a pressure bar which is rotatably supported at one side on the second bending bar. Consequently, although a flexion of the lower or second bending bar brings about in the proposed C-frame press a lowering of the second ram device or the table or the passive ram, it does not bring about any torsion. The necessary parallelisms with respect to the pressing direction are consequently also reliably maintained with high pressing forces.

Furthermore, the division of the press frame into four functional elements, that is to say, the first and the second bending bars and the tension column and the pressure column, provides overall smaller components for processing and transporting. The entire press frame is then composed of four individual members which simplifies the processing of the individual elements and the transport thereof. A variation of the press height may also, for example, be provided simply by exchanging the tension column and the pressure column. All the other modules of the proposed C-frame press, for example, the bending bars and the ram devices, can continue to be used in an unchanged state. For example, it is also possible to replace only one of the bending bars with the ram device which is associated initially if, for example, an active ram is intended to be introduced in place of a passive ram. It is thereby possible to adapt the C-frame press to different requirements in terms of complexity and for the forces to be applied to be scaled in relation to dimensions.

In one refinement of the C-frame press, there may be provision for the tension column and the pressure column to extend longitudinally parallel with the pressing direction.

That particularly simple structural construction ensures that the tension column is simply subjected to tension stresses and the pressure column is substantially or mainly loaded with pressure stresses. Furthermore, the pressure column may be provided to receive forces which are also located in a plane extending perpendicularly to the pressing direction.

In another refinement of the C-frame press, there may be provision for the pressure column to be arranged at an end of the first bending bar and the second bending bar, which end faces away from the first ram device and the second ram device, and for the tension column to be arranged between the pressure column and the first and the second ram device.

In this instance, in particular the pressure column may be arranged at an end facing away from the ram of the first ram device or at an end facing away from the ram or table of the second ram device. In particular the tension column may be arranged adjacent to the rams or the ram and the table of the first ram device.

In this manner, the described pressure application to the pressure column and tension application to the tension column are provided in the pressure frame provided when the pressing force is applied. At the same time, there is achieved a favorable load distribution in which the tension column takes up a large portion of the counter-forces of the pressing force applied. A bending loading of the first bending bar and the second bending bar is kept small.

In another refinement, there may be provision for the tension column to have the respective linear guide which guides the first ram device and/or the second ram device parallel with the pressing direction. There may be provision as an alternative in particular for the respective linear guide which guides the first ram device and/or the second ram device parallel with the pressing direction to be supported in the press frame by means of a bearing which is torque-free about an axis which extends perpendicularly to the frame plane. Those linear guides can then be provided separately from the tension column.

It is thereby ensured that the linear guide extends parallel with the pressing direction and the first ram device and the second ram device are moved parallel with the pressing direction and that parallelism is also not lost in the event of application of a pressing force. Displacements in a horizontal direction, that is to say, perpendicularly to the pressing direction, are avoided. The provision of an angled member for the guiding is also avoided. In particular, the use of the tension column present in any case with a double function as a simultaneous linear guide results in a simplification of the structural construction and saving of materials.

In another refinement, there may be provision for the first ram device and the second ram device to be guided in separate linear guides or to be guided together in a linear guide or a single linear guide.

In principle, both of those alternatives are conceivable. In particular, if the tension column has the linear guide, it may be advantageous to provide a corresponding linear guide over the entire longitudinal extent of the tension column. Such a linear guide may, for example, be constructed as a rolling contact bearing, in particular as a roller bearing, but also as a sliding bearing. For example, in the event that the first ram device has an active ram, that is to say, has a ram which is driven by means of a drive device, and the second ram device has a passive ram, that is to say, has substantially only a table which is supported in a torque-free manner and which can be moved along the linear guide, there may also be provided a separate bearing as a result of the movement operations of the active ram and passive ram over different lengths. For example, different types of linear guides can then also be used. For example, passive rams can be guided in a sliding bearing. However, the active ram can then be guided in a roller bearing.

In another refinement, there may be provision for the first ram device to be guided in a linear guide which extends parallel with the pressing direction, and wherein the second ram device is guided in a linear guide which extends parallel with the pressing direction.

In this refinement, consequently, both ram devices are guided in a linear guide parallel with the pressing direction. In this manner, horizontal displacements during the pressing operation can be prevented particularly well.

In another refinement, there may be provision for only either the first ram device or the second ram device to be guided in a linear guide which extends parallel with the pressing direction.

In this refinement, only one of the two ram devices is guided in a linear guide parallel with the pressing direction. In this manner, it is already possible to prevent horizontal displacements during the pressing operation. The other of the first and second ram devices can then be guided in a guide parallel with the pressing direction. That guide can then be configured in any manner.

In another refinement, there may be provision for the first ram device to be guided in a linear guide which extends parallel with the pressing direction, and wherein the second ram device is guided by means of at least one lever element which extends perpendicularly to the pressing direction. In this instance, in particular the first ram device may have the at least one drive device.

In this refinement, only the first ram device is guided in a linear guide parallel with the pressing direction. In this manner, horizontal displacements during the pressing operation can already be prevented. The guide of the second ram device is provided by means of a lever element which extends perpendicularly to the pressing direction. The lever element may be connected to the press frame, the tension column or the pressure column by means of a bearing which is torque-free about an axis which extends perpendicularly to the frame plane. In particular, the lever element is connected by means of a bearing which is torque-free about an axis which extends perpendicularly to the frame plane in the region of an end of the press frame remote from the first ram device and the second ram device, in particular at the remote end of the press frame. The length of the lever element is consequently great. The radius which the movement of the lever element describes during a movement of the second ram device is also great. Particularly if the second ram device is in the form of a passive ram, horizontal displacements are then only very small or negligible.

In another refinement, there may be provision for the second ram device to be guided in a linear guide which extends parallel with the pressing direction, and wherein the first ram device is guided by means of at least one lever element which extends perpendicularly to the pressing direction, in particular wherein the second ram device has the at least one drive device.

In this refinement, only the second ram device is guided in a linear guide parallel with the pressing direction. In this manner, horizontal displacements during the pressing operation can already be prevented. The guiding of the first ram device is provided by means of a lever element which extends perpendicularly to the pressing direction. The lever element may be connected to the pressing frame, tension column or pressure column by means of a bearing which is torque-free about an axis which extends perpendicularly to the frame plane. In particular the lever element is connected in the region of an end of the press frame remote from the first ram device and the second ram device, in particular at the remote end of the press frame, by means of a bearing which is torque-free about an axis which extends perpendicularly to the frame plane. The length of the lever element is consequently great. The radius which the movement of the lever element describes during a movement of the first ram device is also great. Particularly if the first ram device is in the form of a passive ram, horizontal displacements are then only very small or negligible.

In another refinement, there may be provision for the tension column and the pressure column to be supported on a base by means of a stand device.

In this instance, the stand device may be fitted to the tension column and the pressure column and may be supported on the base or even connected thereto.

In another refinement, there may be provision for the pressure column to be connected to the first bending bar and to the second bending bar by means of a fixed bearing, transmits at least a torque which acts about an axis which extends perpendicularly to the frame plane and a force which acts parallel with the frame plane and perpendicularly to the pressing direction.

In this manner, the pressure column acts at the side of the C-frame press facing away from the workpiece as a rear connection of the two bending bars and serves to stiffen the C-frame press in order to prevent displacements of the bending bars perpendicularly to the pressing direction.

In another refinement, there may be provision for only either the first or the second ram device to have at least one drive device and for the correspondingly other one of the first and second ram device to be constructed as a passive ram which is guided in the respective linear guide which extends parallel with the pressing direction and which is supported on the press frame by means of a pressure bar via a bearing which is torque-free about an axis which extends perpendicularly to the frame plane.

As already described above, the passive ram substantially takes up the function known from a table during the processing of a workpiece. In this manner, the C-frame press is constructed in such a manner that an active ram which applies a pressing force by means of a drive device is formed either from above or from below. The other ram device is constructed as a passive ram. Preferably, the upper ram device in the operating position of the C-frame press is constructed as an active ram and the lower ram device in the operating position of the C-frame press is constructed as a passive ram. Unlike the prior art, however, the passive ram is not rigidly supported in the press frame but is instead supported on the press frame by means of a pressure bar via a bearing which is torque-free about an axis extending perpendicularly to the frame plane and is guided in a linear guide parallel with the pressing direction. In this manner, a bending open of the press frame does not bring about any torsion of the passive ram but instead only a slight displacement in the pressing direction.

In another refinement, there may be provision for both the first ram device and the second ram device to have at least one drive device.

Consequently, it is possible for both ram devices to be constructed as active rams and to contribute to the application of the pressing force. The application of the pressing force to the tool or the workpiece by means of two opposing press rams affords many advantages. In particular, for example, a closing travel and a working travel can be carried out with a separate drive system. It is possible, for example, for the closing travel to be carried out initially by means of one ram device and the working travel subsequently by means of the other ram device. Consequently, the drive devices can be configured with respect to those specific requirements. The closing travel forms as a result of a long travel path a high speed but only with little force. However, the working travel is travelled over a short travel path with high force. Furthermore, this configuration allows a higher total travel, in particular in the case of knee lever drives. At least a double travel can obviously be produced. An energy saving can also be obtained by means of those systems because, for example, a plate holder does not have to carry out any work after the closing travel during the working travel carried out by means of the other drive device.

In another refinement, there may be provision for at least one of the first ram device and the second ram device to have at least two drive devices which are articulated to a ram of the respective ram device so as to be adjustable separately from each other and so as to be offset perpendicularly to the pressing direction.

In this manner, consequently, a ram of the respective ram device is acted on with a force at two different locations. In this manner, the force applied to the ram is introduced into the ram at a plurality of locations and is distributed uniformly over a large surface-area. This allows a relatively large table depth. As a result of the separate adjustability, however, it is also further possible to retain the rams or the tools introduced perpendicularly to the pressing direction precisely with rams with a great depth. In that the movement of this ram is carried out by two drive devices which can be adjusted separately from each other and which each act at the rear ram side and at the front ram side when considered in the depth direction, it is possible to prevent the linear guide from being loaded by eccentric forces. As described, a depth of the rams can be increased. The dimension “deep” refers in this instance to the dimension inside the frame plane and perpendicular to the pressing direction. A table width, that is to say, an extent of the table perpendicular to the frame plane, may be kept the same and in this instance higher pressing forces can be applied by the increased number of drive devices.

In particular in this refinement, there may be provision for precisely two drive devices to be provided in at least one of the first ram device and the second ram device. In this case, each of the drive devices may have an knee lever, wherein the knee levers are configured in opposing manners. In this manner, the corresponding ram device has an opposing knee lever pair. This has the advantage that, for example, no horizontal reaction force is applied to the linear guide during the working stroke.

In a refinement, there may be provision for at least one of the first ram device and the second ram device to have a drive device which has two knee levers which are connected in the same direction and which are articulated to a ram of the respective ram device in a manner offset relative to the pressing direction. In particular, there may be provision in this instance for the two knee levers which are connected in the same direction to be driven together via at least one drive unit, in particular precisely one drive unit.

In this manner, it is possible to introduce the pressing force at a plurality of locations into the respective ram by means of a single drive unit and to distribute it in particular over a relatively great depth of the ram. In this manner, it is also possible to increase the table depth.

In a refinement, there may be provision in this instance for at least one of the two knee levers which are connected to each other in the same direction to be fitted to the press frame so as to be adjustable in a direction parallel with the pressing direction.

In this manner, an inclination of the respective ram can be compensated for via the adjustability of one knee lever of the two knee levers which extend in the same direction. This allows loads of the linear guides to be prevented by the inclination of the respective ram.

In this instance, there may in particular be provision for the adjustable fitting to the press frame to be provided by means of an eccentric.

In this manner, it is possible in a particularly simple manner to change, by means of the eccentric, the desired adjustment of the articulation of the respective knee lever to the press frame in a direction parallel with the pressing direction. The eccentric allows a stepless and fine adjustment in the pressing direction during cooperation with a drive unit with low forces.

In another refinement of the C-frame press, there may be provision for at least one of the first ram device and second ram device to have an inclination sensor device which detects an inclination of a ram of the respective ram device relative to the tension column and/or a linear guide. In particular, both ram devices may have an inclination sensor device.

In this manner, it is possible to detect an inclination of a respective ram. In this instance, an angle between the respective ram and the associated linear guide is particularly detected. In the case of the desired orientation, this angle is precisely 90°. The respective ram is orientated perpendicularly to the linear guide in the case to be adjusted. Deviations can be detected by means of an inclination sensor. It can thereby be established whether a respective ram “is suspended” or is “tilted” upward with respect to the linear guide. By means of the above-described adjustment method, in particular by means of an eccentric, it is possible to react thereto in a control circuit and to retain the desired perpendicular arrangement of a respective ram with respect to the associated linear guide. This then allows at the same time the parallel orientation of the rams of the first ram device and the second ram device perpendicularly to the pressing direction, respectively.

In a refinement, there may be provision in this case for the inclination sensor device to be formed by at least two spacing sensors which are arranged on the respective ram in a state offset parallel with the pressing direction and which each measure a spacing between the ram and the respective linear guide perpendicularly to the pressing direction.

In this manner, an inclination relative to the linear guide can be measured. In the case of the desired perpendicular orientation, the spacings would be identical to at least two spacing sensors. If they differ from each other, conclusions can be drawn about the inclination.

In another refinement, there may be provision for the inclination sensor device to be formed by at least two spacing sensors which are arranged on the respective ram in a state offset perpendicularly to the pressing direction and which each measure a spacing between the ram and a reference bar parallel with the pressing direction, wherein the reference bar extends perpendicularly to the pressing direction from the tension column and/or a linear guide.

In particular, there may be provision for the reference bar to be formed in one piece with the tension column. In principle, however, it may also be connected to the tension column in a fixed manner as a separate element. The reference bar consequently extends perpendicularly to the pressing direction. As a result of the integral construction and the connection to the tension column, the orientation thereof also does not change in the event of application of the pressing force. Consequently, the inclination of the respective ram with respect to the reference bar can also be established here by means of at least two spacing sensors. It is also possible to draw conclusions therefrom regarding the inclination with respect to the tension column and the linear guide. If the spacings measured by means of the at least two spacing sensors are identical, the respective ram is also orientated as desired in this instance. If the at least two spacing sensors establish different spacings, conclusions can be drawn from the difference with regard to the inclination of the respective ram with respect to the reference bar.

In another refinement, there may be provision for the at least one drive device to have a ram, wherein there is constructed in a longitudinally adjustable manner a lever element which is articulated to the ram in order to be adapted to an installation height of a tool which is arranged on the ram.

In particular, the longitudinal adjustment can be formed by a threaded spindle. In particular, the drive device may have a knee lever, of which the lever element which is articulated to the respective ram is provided with a threaded spindle or is constructed as a threaded spindle in order to adjust the length thereof. In this manner, tools of different structural height can be used. In principle, there may also be provision for a lever element of the drive device to be constructed so as to be longitudinally adjustable so that length is articulated directly to the ram. In this manner, under some circumstances, it is possible to carry out adaptation to the different structural heights of tools.

In another refinement of the C-frame press, there may be provision for the at least one drive device to have a ram and at least one drive unit which drives the ram. In particular, the drive unit may directly drive the ram, in particular the drive unit may be at least one hydraulic cylinder or at least one servo-spindle.

The drive device can be provided in a manner which is simple in principle with this drive unit.

In another refinement, there may be provision for the at least one drive device to have a ram and at least one drive unit which drives the ram via at least one knee lever, wherein a force-displacement-path of the at least one knee lever can be adjusted via an adjustment device.

In particular the adjustment device may be, for example, a disk having a plurality of articulation locations. It is also conceivable to have a disk having two halves which are adjustable relative to each other in terms of direction. Such drive devices having an adjustable force-displacement-path which may be used in the context of the present invention are described in the publication WO2014/063841 A1 by the same Applicant, the disclosure of which is incorporated in the present application by reference.

It will be understood that the above-mentioned features and those explained below may be used not only in the combination set out but also in other combinations or alone without departing from the scope of the present invention.

### BRIEF DESCRIPTION OF THE DRAWINGS

Embodiments of the invention are illustrated in the drawings and are explained in greater detail in the following description. In the drawings:

FIG. 1 shows a C-frame press according to the prior art,

FIG. 2 shows an embodiment of a C-frame press according to the invention,

FIG. 3 shows another embodiment of a C-frame press according to the invention,

FIGS. 4a and 4b show another embodiment of a C-frame press according to the invention, wherein the deformations resulting during application with a pressing force are schematically indicated in FIG. 4b,

FIG. 5 shows another embodiment of a C-frame press according to the invention,

FIG. 6 shows another refinement of a C-frame press according to the invention,

FIGS. 7a and 7b show another embodiment of a C-frame press according to the invention, wherein the cutout B designated in FIG. 7a is illustrated to a larger scale in FIG. 7b,

FIG. 8 shows another embodiment of a C-frame press according to the invention,

FIG. 9 shows yet another embodiment of a C-frame press according to the invention,

FIG. 10 shows yet another embodiment of a C-frame press according to the invention,

FIG. 11 shows yet another embodiment of a C-frame press according to the invention, and

FIG. 12 shows yet another embodiment of a C-frame press according to the invention.

### DETAILED DESCRIPTION OF THE PREFERRED EMBODIMENTS

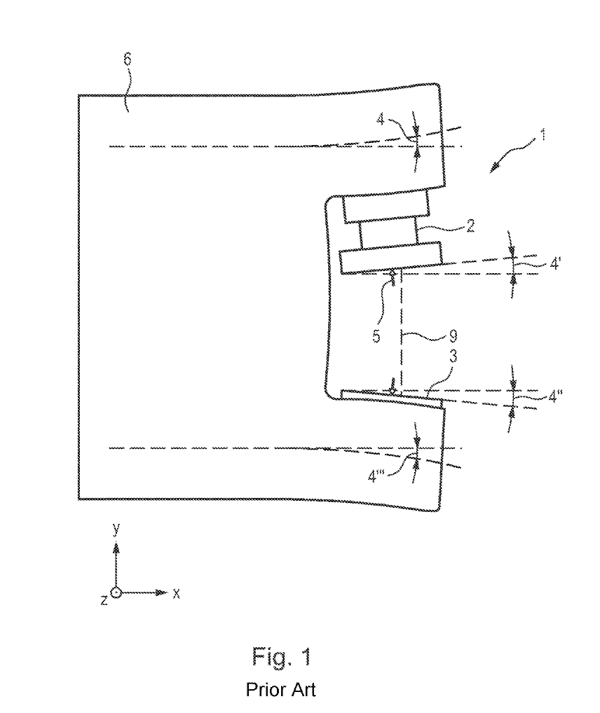

FIG. 1 shows a known C-frame press according to the prior art with reference to which, as described in the introduction to the description, the problems of bending open during application of force are explained. The state illustrated consequently corresponds to the bent-open position during application of force as an exaggerated depiction.

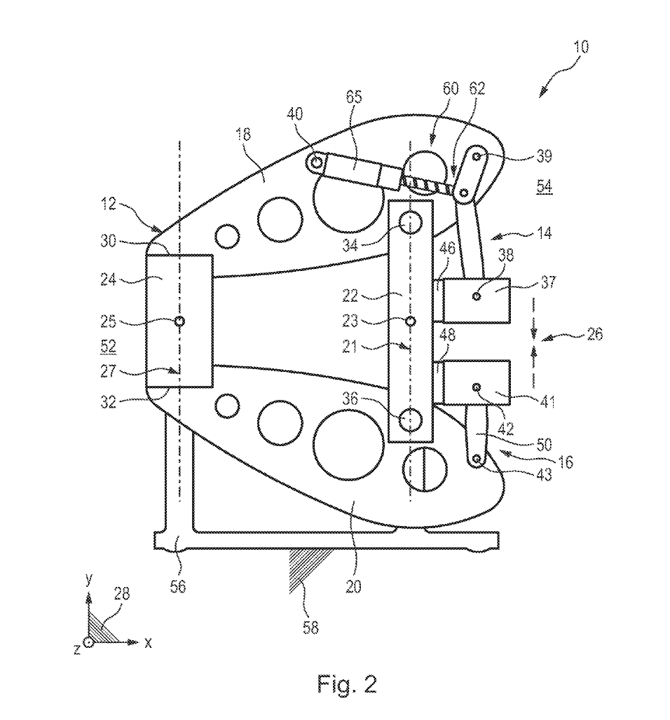

FIG. 2 shows a C-frame press 10 according to the invention. The C-frame press 10 according to the invention has a press frame 12.

The press frame 12 has a first bending bar 18 and a second bending bar 20. The first bending bar 18 is arranged “in the upper position” in the embodiment provided in an operating position of the C-frame press 10. The second bending bar 20 is accordingly arranged “in the lower position”. The first bending bar 18 and the second bending bar 20 are connected to each other by means of a tension column 22 and a pressure column 24.

The first bending bar 18, the second bending bar 20, the tension column 22 and the pressure column 24 define a frame plane 28. In the view illustrated in FIG. 2, the frame plane 28 is the X-Y plane. The frame plane 28 can be defined by a longitudinal axis 21 of the tension column 22 and a longitudinal axis 27 of the pressure column 24. In particular, the frame plane 28 can be defined by the geometric center points of the first bending bar 18, the second bending bar 20, the tension column 22 and the pressure column 24. There may be provision for the press frame 12 to be constructed symmetrically in a Z direction. The frame plane 28 can then be the plane of symmetry of the press frame 12.

The C-frame press 10 has a first ram device 14 and a second ram device 16. The first ram device 14 is associated with the first bending bar 18. The second ram device 16 is associated with the second bending bar 20. A ram 37 of the first ram device 14 and a ram 41 of the second ram device 16 are opposite each other. The rams 37 and 41 are movable relative to each other in a pressing direction 26. In an operating position of the C-frame press 10, the pressing direction is the vertical direction. It is still the case for the frame plane 28 that in an operating position of the C-frame press 10 the frame plane 28 is a vertical plane which extends through the geometric center 23 of the tension column 22 and the geometric center 25 of the pressure column 24. The geometric center 23 of the tension column 22 and the geometric center 25 of the pressure column 24 are schematically illustrated in FIG. 2. In the case of an extension of the tension column 22 or the pressure column 24 in a Z direction, the geometric centers 23, 25 are accordingly inside the tension column 23 or the pressure column 24.

The first bending bar 18 is connected to the pressure column 24 by means of a fixed bearing 30. The second bending bar 20 is connected to the pressure column 24 by means of a fixed bearing 32. The fixed bearings 30, 32 each transmit at least forces in an X direction, that is to say, in a horizontal direction or direction perpendicular to the pressing direction 26. Furthermore, the fixed bearings 30, 32 transmit torques about the Z axis or about a direction perpendicular to the frame plane 28 and therefore also forces in a Y direction.

The tension column 22 is connected to the first bending bar 18 by means of a first tension column bearing 34. Furthermore, the tension column 23 is connected to the second bending bar 20 by means of a second tension column bearing 36. The tension column bearing 34, 36 may be, for example, a rotary bearing. In general terms, the tension column bearings 34, 36 are constructed in such a manner that they do not transmit any torques about the Z direction or about a direction extending perpendicularly to the frame plane 28. Consequently, a bearing which is torque-free about a direction which extends perpendicularly to the frame plane 28 is involved. For example, it may be provided by means of a bolt connection between the first bending bar 18 or the second bending bar 20 and the tension column 22. In this manner, bending bars 18, 20 no moments at all can be introduced into the tension column 22 during application of a pressing force in the pressing direction 26. The tension column 22 is loaded only in terms of tension. Corresponding pressure forces are introduced into the pressure column 24 via the fixed bearings 30, 32. It is thereby ensured that the tension column 22 also retains in the Y direction or parallel with the pressing direction 26 in the event of application of a pressing force in the pressing direction 26. In other words, a straight line always extends between the tension column bearings 34 and 36 parallel with the pressing direction 26.

The first ram device 14 is supported on the press frame 12 by means of a bearing which is torque-free about an axis perpendicular to the frame plane 28 or the Z direction. More specifically, the first ram device 14 is supported on the first bending bar 18 by means of a bearing 38, 39, 40 which is torque-free about an axis which is perpendicular to the frame plane 28. The same applies to the second ram device 16. It is supported in the press frame 12 by means of a bearing 42, 43 which is torque-free about an axis which is perpendicular to the frame plane 28. More specifically, the second ram device 16 is supported on the second bending bar 20 by means of the bearing 42, 43 which is torque-free about a to the frame plane 28.

The torque-free bearing of the first ram device 14 is provided by the ram 37 of the first ram device 14 being articulated via a first drive device 60 which is in turn supported on the first bending bar 18 by means of rotary bearings 39, 40. Naturally, other numbers of articulation locations can also be selected with respect to the first bending bar 18 or the ram 37. However, it is important that the support of the first ram device 14 or the ram 37 of the first ram device 14 be carried out on the first bending bar 18 in such a manner that an axis which extends perpendicularly to the frame plane 28 is again torque-free. The same applies to the second ram device 16 or the ram 41 thereof and the support thereof on the second bending bar 20. In the embodiment illustrated, the second ram device 16 is constructed as a passive ram. The ram 41 is supported on the second bending bar 20 by means of a pressure bar 50. In this instance, the pressure bar 50 is, for example, articulated to the ram 41 by means of a rotary bearing 42 and supported on the second bending bar 20 by means of an additional rotary bearing 43. In this manner, the second ram device 16 or the ram 41 thereof is also supported on the second bending bar 20 or the press frame 12 by means of a bearing which is torque-free about an axis perpendicular to the frame plane 28.

The ram 37 of the first ram device 14 is guided parallel with the pressing direction 26 by means of a linear guide 46. The linear guide 46 is arranged in the embodiment illustrated on the tension column 22. The second ram device 16, more specifically the ram 41 thereof, is also guided parallel with the pressing direction 26 by means of a linear guide 48 which is arranged on the tension column 22. The torque-free support of the first ram device 14 on the press frame 12 or the first bending bar 18 and the linear guide 46 parallel with the pressing direction 26 ensure that the ram 37 of the first ram device 14 moves parallel in the pressing direction 26. There is produced no introduction of torque into the ram 37 and no torsion of the first ram device 14 and the torque-free support on the first bending bar 18 of the press frame 12. The linear guide 46 ensures that the ram 37 cannot move in the X direction, that is to say, perpendicularly to the pressing direction 26, and is guided in the pressing direction 26. The same applies to the second ram device 16. It is ensured that the ram 41 of the second ram device 16 does not become inclined or rotated during application of pressure. The torque-free bearing 42, 43 on the second bending bar 20 of the press frame 12 causes the ram 41 to retain its orientation, even in the event of application of pressure and bending of the second bending bar 20, and only to be lowered slightly in a negative Y direction, that is to say, downward. This results from the bearing location 43 being lowered during application of pressure. The linear guide 48 ensures that, although the ram 41 of the second ram device 16 can move in a negative manner in a Y direction together with the pressure bar 50, it retains the position thereof perpendicular to the pressing direction 26, that is to say, in the X direction.

In the event of an application of pressing force, consequently, the bending bars 18, 20 bend. However, the tension column 22 retains its orientation parallel with the pressing direction 26, that is to say, parallel with the Y direction, as a result of the torque-free bearing 34, 36. The same applies to the first ram device 14 and the second ram device 16 as a result of the torque-free support 38, 39, 40 or 42, 43 thereof on the first bending bar 18 and the second bending bar 20 of the press frame 12. A bending-open action of the ram devices is thus prevented and they also retain their orientation in the event of being acted on with a pressing force. In this instance, the linear guides 46, 48 retain the position of the ram devices 14, 16 or the rams 37, 41 thereof perpendicular to the pressing direction 26. In the embodiment illustrated, the linear guides 46, 48 are arranged on the tension column 22 which also retains the position thereof relative to the pressing direction 26 so that no inclinations at all are also thereby produced. In an alternative embodiment, there may naturally also be provision for the linear guides 46, 48 or a common linear guide for both rams 37, 41 to be arranged on an element which is separated from the tension column 22 and which is then again connected to the press frame, in particular the first bending bar 18 and the second bending bar 20, by means of a bearing which is torque-free about an axis which extends perpendicularly to the frame plane 28. This may be carried out similarly to the bearings 34, 36.

The rams 37, 41 are arranged at an end 54 of the first bending bar 18 and the second bending bar 20, which end faces the rams. An end 52 of the bending bars 18, 20 is located opposite this end 54, which end 52 faces away from the ram devices 14, 16 or the rams 37, 41. The pressure column 24 is arranged at this remote end. This serves in particular to achieve particularly favorable lever ratios. The tension column 22 is consequently arranged adjacent to the rams 37, 41 in the direction toward the end 54 facing the rams. In other words, the tension column 22 is arranged between the ram devices 14, 16 or the rams 37, 41 and the pressure column 24.

A stand device 56 is connected to the tension column 22 and the pressure column 24. The C-frame press 10 is supported on a floor 58 or connected thereto by means of the stand device 56.

In the embodiment illustrated in FIG. 2, only the first ram device 14 has a first drive device 60. Consequently, the ram 37 of the first ram device 14 can act as an active ram. The second ram device 16 does not have its own drive device. The ram 41 of the second ram device 16 therefore acts as a passive ram. In conventional terminology, therefore, the ram 37 of the first ram device 14 would most probably be referred to as a “ram” and the passive ram 41 of the second ram device 16 as a “table”.

The drive device 60 has a kinematic mechanism 62 in the form of an knee lever. Furthermore, there is provided a drive unit 65 which is operatively connected to the ram 37 via the kinematic mechanism 62. The drive unit 65 may be, for example, a pressure cylinder or a servo-spindle.

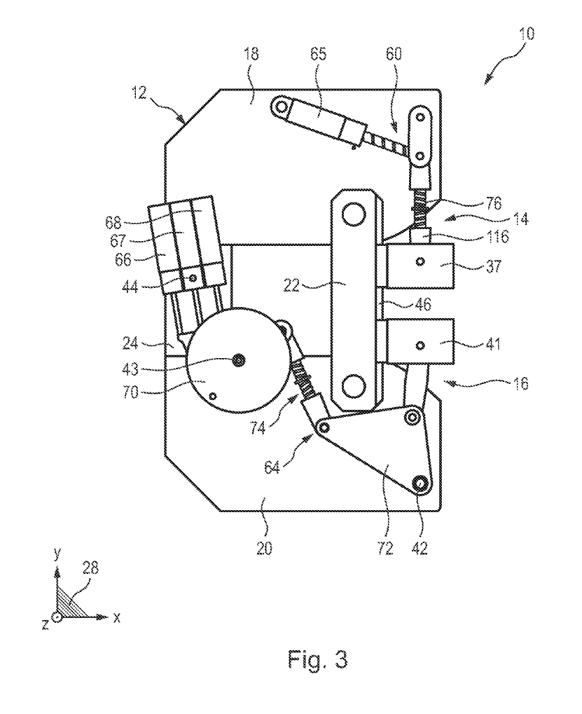

FIG. 3 shows another embodiment of the present invention. The same elements are indicated using the same reference numerals and act in the manner described above. Therefore, they are not explained again in detail.

The embodiment illustrated in FIG. 3 differs from that of FIG. 2 in that both the first ram device 14 and the second ram device 16 are constructed as active rams, that is to say, both the ram 37 and the ram 41 can be acted on with a pressing force. The second ram device 16 consequently has a drive device which is generally designated 64 as the second drive device. The second drive device has a lever disk 70 and a kinematic mechanism which has an knee lever and which is driven by means of three drive units 66, 67, 68. It will be understood that in this embodiment the second ram device 16 is also supported on the press frame 12 with a torque-free bearing 42, 43, 44. The ram device 16 is supported on the second bending bar 20 by means of the bearing 42, 43 which is torque-free about an axis perpendicular to the frame plane 28. The ram 37 in the form of an active ram and the ram 41 in the form of an active ram are both guided in a common linear guide 46 which is arranged on the tension column 22. For example, a positioning travel can thereby first be carried out by means of the first ram device 14 and subsequently a working travel can be carried out by means of the second ram device 16.

A force/displacement path of the drive device 64 can be adjusted as desired by means of the adjustment device 74 in the kinematic mechanism of the drive device 64. To this end, for example, articulation locations or force input or force output locations with respect to the lever disk 70 can also be changed. Embodiments in this regard are explained in the application WO 2014/063841 A1 by the same Applicant which is included in the introduction by reference.

Furthermore, an adjustment device 76 is provided in the ram device 14. It serves to lengthen or shorten a lever which is articulated to the ram 37. In this manner, the C-frame press can be adapted to different installation heights of tools or tool halves which are fitted to the rams 37 or 41.

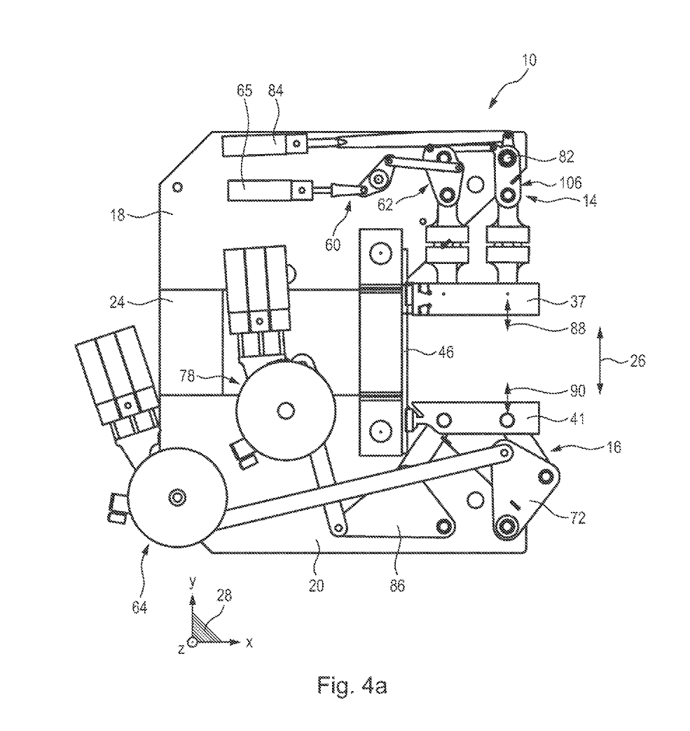

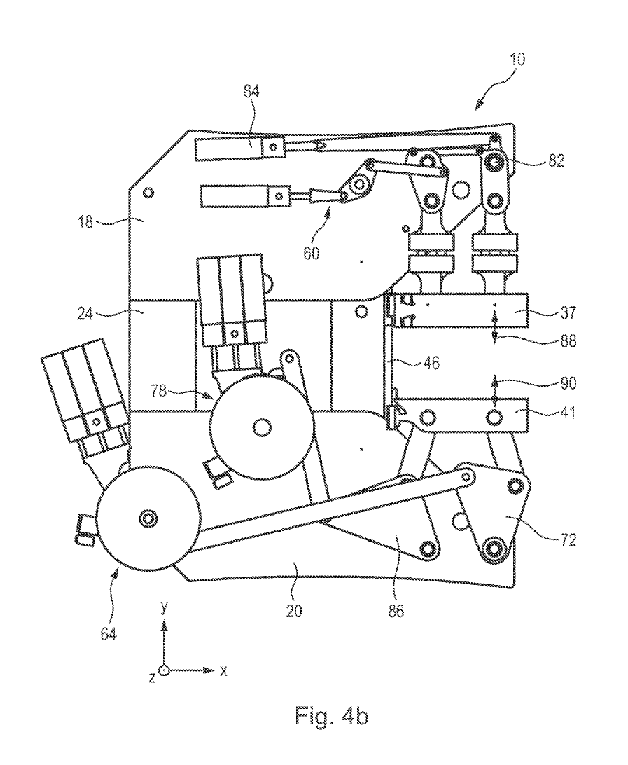

FIGS. 4a and 4b show another embodiment of a C-frame press 10 according to the invention. In this instance, FIG. 4a shows an unloaded state. FIG. 4b illustrates a bending of the bending bars 18, 20 during a pressing force application as an exaggerated illustration. Similar elements are again indicated with similar reference numerals and act in the above-described manner so that they are not explained in detail again. Only specific features are discussed below.

In the embodiment illustrated in FIGS. 4a and 4b, the first ram device 14 has a drive device 60. The first drive device drives with the drive unit 65 thereof two knee levers 62 and 106 which are connected in the same direction.

In this instance, the second knee lever 106 is supported by means of an eccentric 82 in the upper bending bar 18 about the Z axis, that is to say, in a torque-free manner, about an axis perpendicular to the frame plane 28. The eccentric can be driven via an additional drive 84. It is thereby possible to control an inclination of the ram 37 relative to the tension column 22 or the linear guide 46. In the case of the second ram device 16, there are provided two separate drive devices 64 and 78 which can be controlled separately from each other. The drive device 64 acts via the knee lever 72 on the ram 41 of the second ram device 16. The drive device 78 acts on the ram 41 via an knee lever 86 acting counter to the knee lever 72. As a result of the opposing knee levers 72, 80, forces can cancel each other out in the X direction in the ram 41 and do not load the linear guide 46. Since both drive devices 64, 78 can be controlled separately from each other, consequently, it is thereby also possible to adjust an inclination of the ram 41 about the Z axis relative to the linear guide 46 by means of corresponding adjustments of the drive devices 64 and 78. The inclination movements which can thereby be carried out by the rams 37 and 41 are indicated by two arrows 88, 90 in an exaggerated manner. It is thereby possible also to retain the rams 37 and 41 in the case of a great ram depth, that is to say, a great extent away from the tension column or in the X direction perpendicular to the pressing direction 26.

Naturally, the drive concepts of the first ram device 14 and the second ram device 16 as illustrated in FIGS. 4a and 4b may also be arranged in a transposed manner, or, for example, the drive concept of the first ram device 14 can also be provided on the second ram device 16, and vice versa.

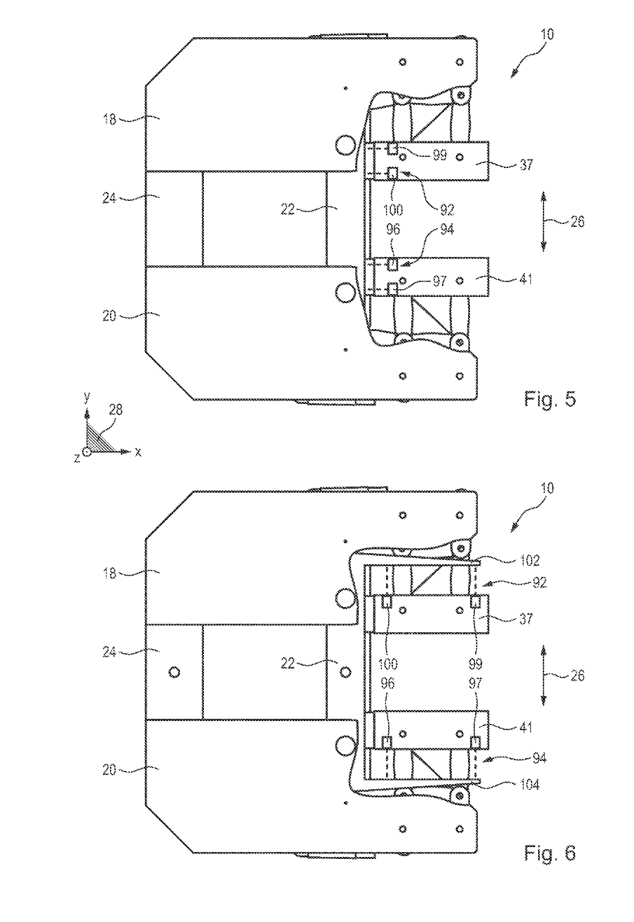

FIG. 5 shows a first embodiment which illustrates how an inclination sensor for the rams 37, 41 can be constructed in the C-frame press 10 according to the invention. The inclination sensor is generally designated 92 in the first ram 37 and 94 in the second ram 41. The first inclination sensor 92 has to this end two spacing sensors 99, 100 which are provided on the ram 37 with spacing from each other parallel with the pressing direction 26. They measure a spacing perpendicular to the pressing direction 26 relative to the tension column 22. This applies accordingly to spacing sensors 96 and 97 of the ram 41 which are spaced apart from each other parallel with the pressing direction 26. If the spacings established by the spacing sensors 99 and 100 are identical, the ram 37 is orientated as desired perpendicularly to the pressing direction 26 and the tension column 22. The same applies to the spacing sensors 96 and 97 of the ram 41. If the spacings are different, an inclination is established and compensation for this inclination can be carried out via a control, for example, by means of the mechanisms set out in connection with FIGS. 4a and 4b.

FIG. 6 illustrates an additional embodiment of an inclination sensor 92 of the ram 37 of the first ram device 14 and an inclination sensor 94 of the ram 41 of the second ram device 16.

The inclination sensor 92 again has two spacing sensors 99 and 100. However, they are arranged in the embodiment illustrated on the ram 37 with spacing from each other perpendicularly to the pressing direction 26. From the tension column 22, a reference bar 102 extends perpendicularly away from the tension column 22, that is to say, also perpendicularly to the pressing direction 26. The spacing sensors 99, 100 each measure a spacing of the ram 37 from the reference bar 102 parallel with the pressing direction 26. The same applies to the spacing sensors 96 and 97 which cooperate accordingly with a reference bar 104. The embodiment illustrated in FIG. 6 may under some conditions determine an inclination of the respective ram 37, 41 with slightly greater precision because the spacing of the spacing sensors 99 and 100 or 96 and 97 can be greater as a result of the depth extent of the rams 37, 41, more specifically a greater extent in an X direction with respect to the extent in a Y direction. Consequently, relatively small inclination angles can also be detected more precisely. In the embodiment of FIG. 6, however, the reference bars must be provided with respect to the embodiment in FIG. 5.

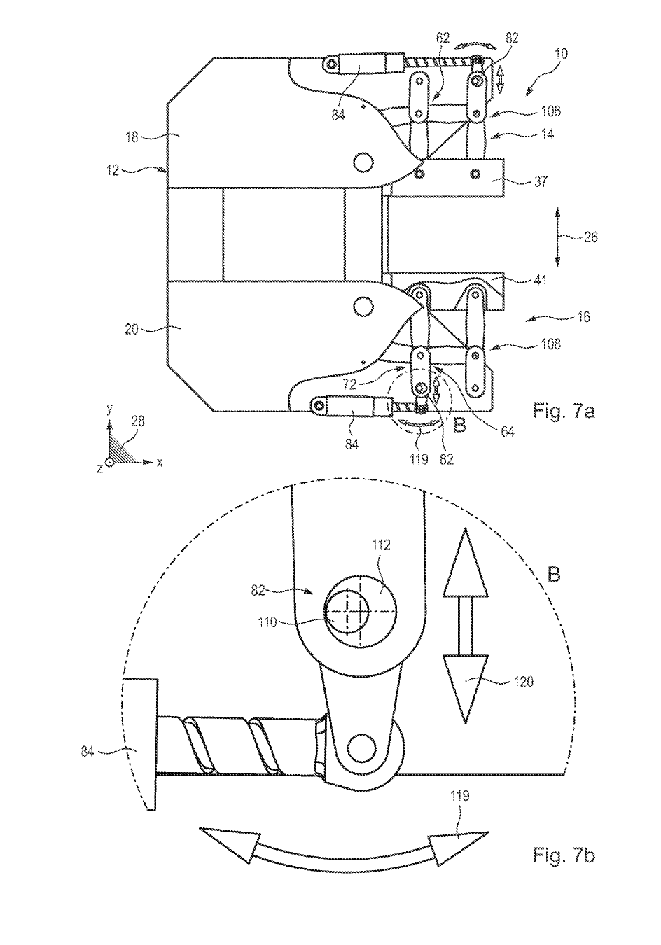

FIGS. 7a and 7b show another embodiment of the present invention. Similar elements are again indicated with the same reference numerals and act in a similar manner. The first ram device 14 has a drive device having two knee levers 62 and 106 acting in the same direction. The second ram device 16 also has a drive device which is constructed in the same manner and which has two knee levers 72 and 108 acting in the same direction. Similarly to what is set out in connection with FIGS. 4a and 4b, one of the knee levers, that is to say, the knee levers 106 and 72, is provided with an eccentric 82. The torque-free support of the respective knee lever 72, 106 on the press frame 12 or the support of the knee lever 106 on the upper bending bar 18 and the support of the knee lever 72 on the lower bending bar 20 are consequently carried out via an eccentric 82. An increase of such a region around the eccentric is illustrated in FIG. 7b. A corresponding eccentric drive device 84, or via a servo-spindle, produces a rotational movement of an eccentric pin 110 as indicated by means of an arrow 119 in an eccentric recess 112 of the respective knee lever 72, 106. It is thereby possible to change the position of the respective knee lever 72, 106 parallel with the pressing direction 26. This results in the movement indicated by means of the arrow 120. It is thereby possible to compensate for an inclination of a respective ram 37 or 41 via the eccentric drive 84, and also to control or retain rams 37, 41 with a great depth, that is to say, extent perpendicular to the pressing direction 26 and away from the press frame 12, in an orientation perpendicular to the pressing direction 26.

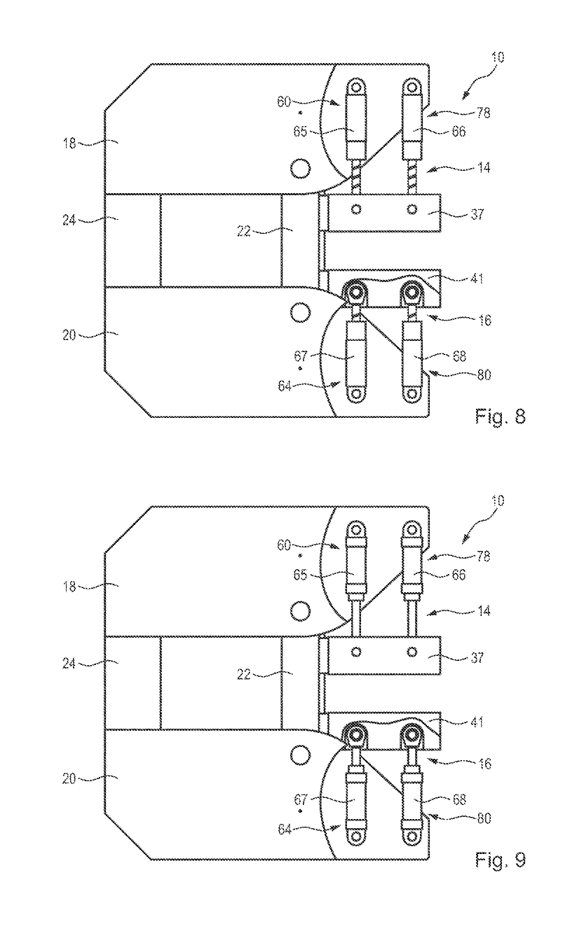

FIG. 8 shows another embodiment of a C-frame press 10. The same elements are again indicated with the same reference numerals and act in the same manner and are therefore not described in greater detail. In the embodiment illustrated in FIG. 8, there are provided in the first ram device 14 two drive devices 60 and 78 which can be controlled separately from each other. Each drive device has a drive unit 65 or 66. The same applies to the second ram device 16 which has two drive units 64 and 80. In this instance, the drive device 64 has the drive unit 67 and the drive device 80 has the drive unit 68. Both or all the drive units 65 to 68 are provided as servo-spindles. Each is directly articulated to the respective ram 37 or 41. Consequently, it is not necessary to provide a kinematic mechanism in the form of knee levers, etc.

FIG. 9 shows another embodiment of the C-frame press 10. It is similar to the embodiment illustrated in FIG. 8. The drive units 65 to 68 are constructed as hydraulic cylinders in this embodiment.

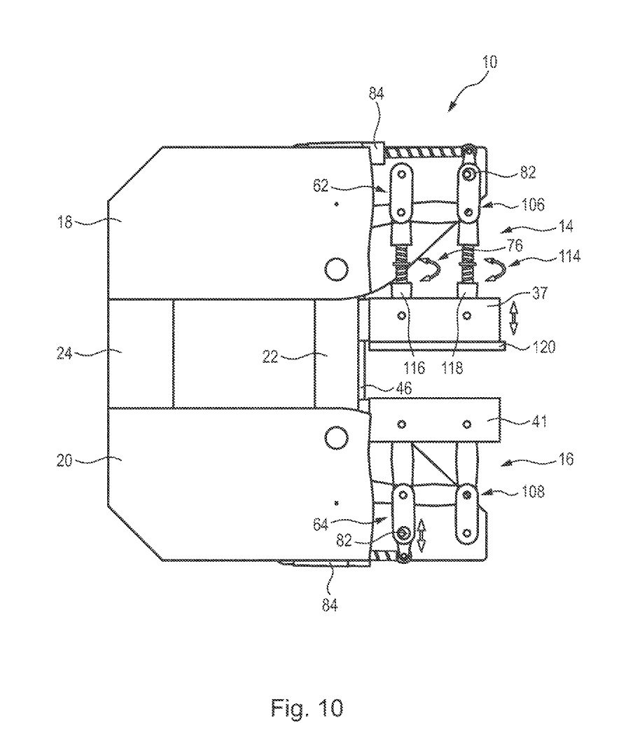

FIG. 10 illustrates another embodiment of a C-frame press 10. The embodiment of FIG. 10 is similar to that of FIGS. 7a and 7b. The same elements are indicated with the same reference numerals and are not explained again. A modification involves the fact that there are provided in the first ram device 14 two adjustment devices 76 and 114 which are in the form of spindles. A tool is schematically designated 120. In order to be able to compensate for different installation heights of this tool 120, the spindles 76 and 114 can be used. They are each provided in a respective lever 116 or 118 which are articulated directly to the ram 37. It is thereby possible to vary the length of the respective lever 116 or 118 and thus for the installation height of the tool 120 to be compensated for when the tool 120 is changed.

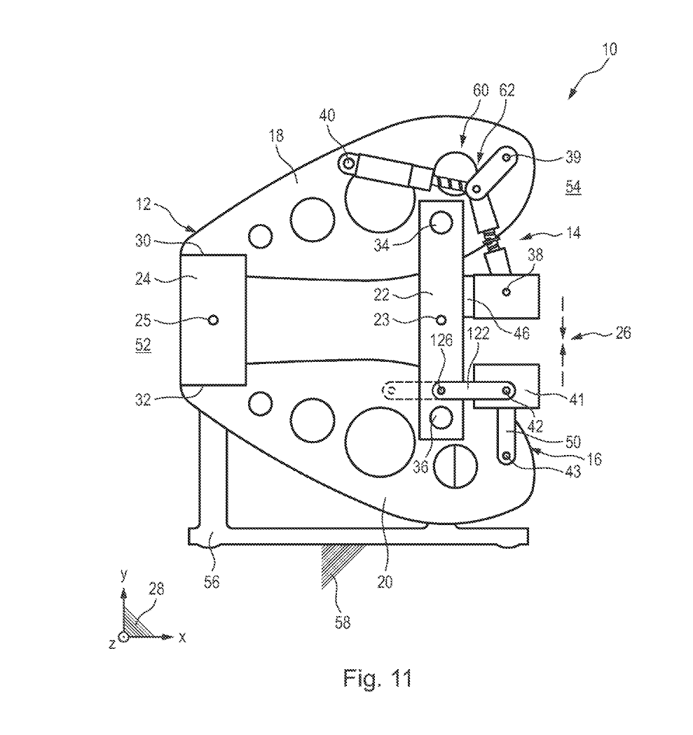

FIG. 11 shows yet another embodiment of a C-frame press 10. The same elements are indicated with the same reference numerals and are not explained again below.

In this embodiment, only the first ram device is guided in the linear guide 46 which extends parallel with the pressing direction 26. The second ram device 16 is guided by means of at least one lever element which extends perpendicularly to the pressing direction 26. In the embodiment illustrated, there is provided precisely one lever element. The first ram device 14 has at least one drive device 60.

The lever element 122 which guides the second ram device 16 in the pressing direction 26 is also supported by means of a bearing 126 which is torque-free about an axis perpendicular to the frame plane 28 or Z direction. The first lever element can in this instance be supported on the tension column 22, the pressure column 24 or the press frame 12. In FIG. 11, the lever element is by way of example supported on the pressure column 126. A support on the press frame 12 is illustrated with broken lines. As mentioned, however, there may in principle also be provided a support on the pressure column 24.

As a result of the relatively long lever element 122 and the construction of the second ram device 16 as a passive ram, there is also thus produced only a slight horizontal displacement during a pressing operation.

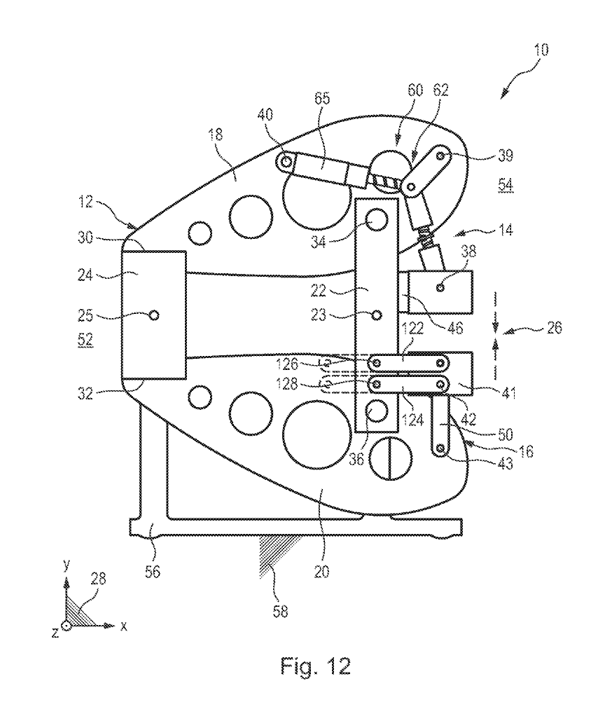

FIG. 12 shows yet another embodiment of a C-frame press 10. In this instance, the same elements are indicated with the same reference numerals and are not explained again.

In the embodiment illustrated, there are provided two lever elements 122, 124 for guiding the second ram device 16. The second lever element 124 is in this instance also supported by means of a bearing 128 which is torque-free about an axis perpendicular to the frame plane 28 or the Z direction. This support can also be brought about on the pressure column 22, the tension column or in the press frame 12. The first lever element 122 and the second lever element 124 can be supported on the same elements in a torque-free manner. In principle, however, it is also conceivable for the first lever element 122 and the second lever element 124 to be supported at various locations in a torque-free manner. Thus, for example, the first lever element 122 can be supported on the press frame 12 in a torque-free manner. The second lever element 124 could be supported on the pressure column 24 in a torque-free manner. Other combinations are naturally also conceivable.

It is also thereby possible to prevent to the greatest possible extent a horizontal displacement during a pressing operation. As a result of the relatively great length of the lever elements 122, 124, a horizontal displacement remains small. The lever elements 122, 124 are not pivoted through great pivot angles, in particular during the construction of the second ram device as a passive ram. The pivot angle will generally be in a range of a few arc minutes or arc seconds. This results in only a very small displacement in the X direction, which is generally within production tolerances, being carried out in the case of a pivoting-out action through a small number of arc minutes or arc seconds about the position illustrated in the Figures perpendicularly to the pressing direction 26.

In continuation of the embodiments in FIGS. 11 and 12, it is naturally also conceivable for the second ram device to be provided with at least one drive device 60 and to be guided by means of the linear guide 48. Accordingly, there may then be provision for the first ram device to be guided by means of at least one lever element 122, 124. In particular, the first ram device would then form a passive ram.

Further, the invention comprises embodiments according to the following clauses:
Clause 1. A C-frame press (10) having a press frame (12), a first ram device (14) and a second ram device (16) which is opposite the first ram device (14), wherein at least one of the first ram device (14) and second ram device (16) has at least one drive device (60, 64, 78, 80) and can be moved relative to the other ram device (14, 16) in a pressing direction (26), wherein the press frame (12) has a first bending bar (18) and a second bending bar (20) which are connected to each other by means of a tension column (22) and a pressure column (24) and which define with the tension column (22) and pressure column (24) a frame plane (28) which extends parallel with the pressing direction (26), wherein the tension column (22) is connected to each of the first bending bar (18) and the second bending bar (20) by means of a bearing (34, 36) which is torque-free about an axis which extends perpendicularly to the frame plane (28), wherein the first ram device (14) and the second ram device (16) are each supported on the press frame (12) by means of a bearing (38, 39, 40; 42, 43, 44) which is torque-free about an axis which extends perpendicularly to the frame plane (28), and wherein the first ram device (14) is guided in a linear guide (46, 48) which extends parallel with the pressing direction (26) and/or the second ram device (16) is guided in a linear guide (46, 48) which extends parallel with the pressing direction (26).
Clause 2. The C-frame press according to clause 1, wherein the tension column (22) and the pressure column (24) each extend longitudinally parallel with the pressing direction (26).
Clause 3. The C-frame press according to clause 1 or clause 2, wherein the pressure column (24) is arranged at an end (52) of the first bending bar (18) and the second bending bar (20), which end (52) faces away from the first ram device (14) and the second ram device (16), and wherein the tension column (22) is arranged between the pressure column (24) and the first (14) and second (16) ram devices.
Clause 4. The C-frame press according to one of clauses 1 to 3, wherein the tension column (22) has the respective linear guide (46, 48) which guides the first ram device (14) and/or the second ram device (16) parallel with the pressing direction (26).
Clause 5. The C-frame press according to one of clauses 1 to 4, wherein the first ram device (14) and the second ram device (16) are guided in separate linear guides (46, 48) or are guided together in a linear guide (46).
Clause 6. The C-frame press according to one of clauses 1 to 5, wherein the first ram device (14) is guided in a linear guide (46, 48) which extends parallel with the pressing direction (26), and wherein the second ram device (16) is guided in a linear guide (46, 48) which extends parallel with the pressing direction (26).
Clause 7. The C-frame press according to one of clauses 1 to 4, wherein only either the first ram device (14) or the second ram device (16) is guided in a linear guide (46, 48) which extends parallel with the pressing direction (26).
Clause 8. The C-frame press according to one of clauses 1 to 4 or according to clause 7, wherein the first ram device (14) is guided in a linear guide (46, 48) which extends parallel with the pressing direction (26), and wherein the second ram device (16) is guided by means of at least one lever element (122, 124) which extends perpendicularly to the pressing direction (26), in particular wherein the first ram device (14) has the at least one drive device (60, 64, 78, 80).
Clause 9. The C-frame press according to one of clauses 1 to 4 or according to clause 7, wherein the second ram device (16) is guided in a linear guide (46, 48) which extends parallel with the pressing direction (26), and wherein the first ram device (14) is guided by means of at least one lever element (122, 124) which extends perpendicularly to the pressing direction (26), in particular wherein the second ram device (14) has the at least one drive device (60, 64, 78, 80).
Clause 10. The C-frame press according to one of clauses 1 to 9, wherein the tension column (22) and the pressure column (24) are supported on the floor (58) by means of a stand device (56).
Clause 11. The C-frame press according to one of clauses 1 to 10, wherein the pressure column (24) is connected to the first bending bar (18) and to the second bending bar (20) by means of a fixed bearing (30, 32), which transmits at least a torque which acts about an axis which extends perpendicularly to the frame plane (28) and a force which acts parallel with the frame plane (28) and perpendicularly to the pressing direction (26).
Clause 12. The C-frame press according to one of clauses 1 to 11, wherein only either the first or the second ram device (16) has at least one drive device (60, 64, 78, 80), and wherein the correspondingly other one of the first and second ram device (16) is constructed as a passive ram which is guided in the respective linear guide (46, 48) which extends parallel with the pressing direction (26) and which is supported on the press frame (12) by means of a pressure bar (50) via a bearing which is torque-free about an axis which extends perpendicularly to the frame plane (28).
Clause 13. The C-frame press according to one of clauses 1 to 11, wherein both the first ram device (14) and the second ram device (16) have at least one drive device (60, 64, 78, 80).
Clause 14. The C-frame press according to one of clauses 1 to 13, wherein at least one of the first ram device (14) and the second ram device (16) has at least two drive devices (60, 78; 64, 80) which are articulated to a ram (37, 41) of the respective ram device (14, 16) so as to be adjustable separately from each other and so as to be offset perpendicularly to the pressing direction (26).
Clause 15. The C-frame press according to one of clauses 1 to 14, wherein at least one of the first ram device (14) and the second ram device (16) has a drive device which has two knee levers (62, 106; 72, 108) which are connected in the same direction and which are articulated to a ram (37, 41) of the respective ram device (37, 41) in a manner offset relative to the pressing direction (26).
Clause 16. The C-frame press according to clause 15, wherein at least one (64; 106) of the two knee levers (62, 106; 72, 108) which are connected to each other in the same direction is fitted to the press frame (12) so as to be adjustable in a direction parallel with the pressing direction (26).
Clause 17. The C-frame press according to clause 16, wherein the adjustable fitting to the press frame (12) is provided by means of an eccentric (82).
Clause 18. The C-frame press according to one of clauses 1 to 17, wherein at least one of the first ram device (14) and second ram device (16) has an inclination sensor device (92, 94) which detects an inclination of a ram (37, 41) of the respective ram device (14, 16) relative to the tension column (22).
Clause 19. The C-frame press according to clause 18, wherein the inclination sensor device (92, 94) is formed by at least two spacing sensors (96, 97; 99, 100) which are arranged on the respective ram (37, 41) in a state offset parallel with the pressing direction (26) and which each measure a spacing between the ram (37, 41) and the respective linear guide (46, 48) perpendicularly to the pressing direction (26).
Clause 20. The C-frame press according to one of clauses 1 to 19, wherein the inclination sensor device (92, 94) is formed by at least two spacing sensors (96, 97; 99, 100) which are arranged on the respective ram (37, 41) in a state offset perpendicularly to the pressing direction (26) and which each measure a spacing between the ram (37, 41) and a reference bar (102, 104) parallel with the pressing direction (26), wherein the reference bar (102, 104) extends perpendicularly to the pressing direction (26) from the tension column (22).
Clause 21. The C-frame press according to one of clauses 1 to 20, wherein the at least one drive device (60, 64, 78, 80) has a ram (37, 41), and wherein there is constructed in a longitudinally adjustable manner a lever element (116, 118) which is articulated to the ram (37, 41) in order to be adapted to an installation height of a tool (120) which is arranged on the ram (37, 41).
Clause 22. The C-frame press according to one of clauses 1 to 21, wherein the at least one drive device (60, 64, 78, 80) has a ram (37, 41) and at least one drive unit (65, 66, 67, 68) which directly drives the ram (37, 41), in particular wherein the drive unit is a hydraulic cylinder or a servo-spindle.
Clause 23. The C-frame press according to one of clauses 1 to 22, wherein the at least one drive device (60, 64, 78, 80) has a ram (37, 41) and at least one drive unit (65-68) which drives the ram (37, 41) via at least one knee lever (62, 72, 86), wherein a force-displacement-path of the at least one knee lever (62, 72, 86) can be adjusted via an adjustment device (70, 74).
Clause 24. The C-frame press according to one of clauses 1 to 23, wherein the first ram device (14) is supported on the first bending bar (18) by means of a bearing (38, 39, 40) which is torque-free about an axis which extends perpendicularly to the frame plane (28), and wherein the second ram device (16) is supported on the second bending bar (20) by means of a bearing (42, 43, 44) which is torque-free about an axis which extends perpendicularly to the frame plane (28).
Clause 25. A C-frame press (10) having a press frame (12), a first ram device (14) and a second ram device (16) which is opposite the first ram device (14), wherein at least one of the first ram device (14) and second ram device (16) has at least one drive device (60, 64, 78, 80) and can be moved relative to the other ram device (14, 16) in a pressing direction (26), wherein the press frame (12) has a first bending bar (18) and a second bending bar (20) which are connected to each other by means of a tension column (22) and a pressure column (24) and which define with the tension column (22) and pressure column (24) a frame plane (28) which extends parallel with the pressing direction (26), wherein the tension column (22) is connected to each of the first bending bar (18) and the second bending bar (20) by means of a bearing (34, 36) which is torque-free about an axis which extends perpendicularly to the frame plane (28), wherein the first ram device (14) and the second ram device (16) are each supported on the press frame (12) by means of a bearing (38, 39, 40; 42, 43, 44) which is torque-free about an axis which extends perpendicularly to the frame plane (28), and wherein the first ram device (14) is guided in a linear guide (46, 48) which extends parallel with the pressing direction (26) and wherein the second ram device (16) is guided in a linear guide (46, 48) which extends parallel with the pressing direction (26).
Clause 26. The C-frame press according to clause 25, wherein the tension column (22) and the pressure column (24) each extend longitudinally parallel with the pressing direction (26).
Clause 27. The C-frame press according to clause 25 or clause 26, wherein the pressure column (24) is arranged at an end (52) of the first bending bar (18) and the second bending bar (20), which end (52) faces away from the first ram device (14) and the second ram device (16), and wherein the tension column (22) is arranged between the pressure column (24) and the first (14) and second (16) ram devices.
Clause 28. The C-frame press according to one of clauses 25 to 27, wherein the tension column (22) has the respective linear guide (46, 48) which guides the first ram device (14) and/or the second ram device (16) parallel with the pressing direction (26).
Clause 29. The C-frame press according to one of clauses 25 to 28, wherein the first ram device (14) and the second ram device (16) are guided in separate linear guides (46, 48) or are guided together in a linear guide (46).
Clause 30. The C-frame press according to one of clauses 25 to 29, wherein the tension column (22) and the pressure column (24) are supported on the floor (58) by means of a stand device (56).
Clause 31. The C-frame press according to one of clauses 25 to 30, wherein the pressure column (24) is connected to the first bending bar (18) and to the second bending bar (20) by means of a fixed bearing (30, 32), which transmits at least a torque which acts about an axis which extends perpendicularly to the frame plane (28) and a force which acts parallel with the frame plane (28) and perpendicularly to the pressing direction (26).
Clause 32. The C-frame press according to one of clauses 25 to 31, wherein only either the first or the second ram device (16) has at least one drive device (60, 64, 78, 80), and wherein the correspondingly other one of the first and second ram device (16) is constructed as a passive ram which is guided in the respective linear guide (46, 48) which extends parallel with the pressing direction (26) and which is supported on the press frame (12) by means of a pressure bar (50) via a bearing which is torque-free about an axis which extends perpendicularly to the frame plane (28).
Clause 33. The C-frame press according to one of clauses 25 to 32, wherein both the first ram device (14) and the second ram device (16) have at least one drive device (60, 64, 78, 80).
Clause 34. The C-frame press according to one of clauses 25 to 33, wherein at least one of the first ram device (14) and the second ram device (16) has at least two drive devices (60, 78; 64, 80) which are articulated to a ram (37, 41) of the respective ram device (14, 16) so as to be adjustable separately from each other and so as to be offset perpendicularly to the pressing direction (26).
Clause 35. The C-frame press according to one of clauses 25 to 34, wherein at least one of the first ram device (14) and the second ram device (16) has a drive device which has two knee levers (62, 106; 72, 108) which are connected in the same direction and which are articulated to a ram (37, 41) of the respective ram device (37, 41) in a manner offset relative to the pressing direction (26).
Clause 36. The C-frame press according to clause 35, wherein at least one (64; 106) of the two knee levers (62, 106; 72, 108) which are connected to each other in the same direction is fitted to the press frame (12) so as to be adjustable in a direction parallel with the pressing direction (26).
Clause 37. The C-frame press according to clause 36, wherein the adjustable fitting to the press frame (12) is provided by means of an eccentric (82).
Clause 38. The C-frame press according to one of clauses 25 to 37, wherein at least one of the first ram device (14) and second ram device (16) has an inclination sensor device (92, 94) which detects an inclination of a ram (37, 41) of the respective ram device (14, 16) relative to the tension column (22).
Clause 39. The C-frame press according to clause 38, wherein the inclination sensor device (92, 94) is formed by at least two spacing sensors (96, 97; 99, 100) which are arranged on the respective ram (37, 41) in a state offset parallel with the pressing direction (26) and which each measure a spacing between the ram (37, 41) and the respective linear guide (46, 48) perpendicularly to the pressing direction (26).
Clause 40. The C-frame press according to one of clauses 25 to 39, wherein the inclination sensor device (92, 94) is formed by at least two spacing sensors (96, 97; 99, 100) which are arranged on the respective ram (37, 41) in a state offset perpendicularly to the pressing direction (26) and which each measure a spacing between the ram (37, 41) and a reference bar (102, 104) parallel with the pressing direction (26), wherein the reference bar (102, 104) extends perpendicularly to the pressing direction (26) from the tension column (22).
Clause 41. The C-frame press according to one of clauses 25 to 40, wherein the at least one drive device (60, 64, 78, 80) has a ram (37, 41), and wherein there is constructed in a longitudinally adjustable manner a lever element (116, 118) which is articulated to the ram (37, 41) in order to be adapted to an installation height of a tool (120) which is arranged on the ram (37, 41).
Clause 42. The C-frame press according to one of clauses 25 to 41, wherein the at least one drive device (60, 64, 78, 80) has a ram (37, 41) and at least one drive unit (65, 66, 67, 68) which directly drives the ram (37, 41), in particular wherein the drive unit is a hydraulic cylinder or a servo-spindle.
Clause 43. The C-frame press according to one of clauses 25 to 42, wherein the at least one drive device (60, 64, 78, 80) has a ram (37, 41) and at least one drive unit (65-68) which drives the ram (37, 41) via at least one knee lever (62, 72, 86), wherein a force-displacement-path of the at least one knee lever (62, 72, 86) can be adjusted via an adjustment device (70, 74).
Clause 44. The C-frame press according to one of clauses 25 to 43, wherein the first ram device (14) is supported on the first bending bar (18) by means of a bearing (38, 39, 40) which is torque-free about an axis which extends perpendicularly to the frame plane (28), and wherein the second ram device (16) is supported on the second bending bar (20) by means of a bearing (42, 43, 44) which is torque-free about an axis which extends perpendicularly to the frame plane (28).

What is claimed is:

1. A C-frame press having a press frame, a first ram device and a second ram device which is opposite the first ram device, wherein at least one of the first ram device and second ram device has at least one drive device and can be moved relative to the other ram device in a pressing direction, wherein the press frame has a first bending bar and a second bending bar which are connected to each other by means of a tension column and a pressure column and which define with the tension column and pressure column a frame plane which extends parallel with the pressing direction, wherein the tension column is connected to each of the first bending bar and the second bending bar by means of a bearing which is torque-free about an axis which extends perpendicularly to the frame plane, wherein the first ram device and the second ram device are each supported on the press frame by means of a bearing which is torque-free about an axis which extends perpendicularly to the frame plane, and wherein the first ram device is guided in a linear guide which extends parallel with the pressing direction and/or the second ram device is guided in a linear guide which extends parallel with the pressing direction.

2. The C-frame press according to claim 1, wherein the tension column and the pressure column each extend longitudinally parallel with the pressing direction.

3. The C-frame press according to claim 1, wherein the pressure column is arranged at an end of the first bending bar and the second bending bar, which end faces away from the first ram device and the second ram device, and wherein the tension column is arranged between the pressure column and the first and second ram devices.

4. The C-frame press according to claim 1, wherein the tension column has the respective linear guide which guides the first ram device and/or the second ram device parallel with the pressing direction.

5. The C-frame press according to claim 1, wherein the first ram device and the second ram device are guided in separate linear guides or are guided together in a linear guide.

6. The C-frame press according to claim 1, wherein the first ram device is guided in a linear guide which extends parallel with the pressing direction, and wherein the second ram device is guided in a linear guide which extends parallel with the pressing direction.

7. The C-frame press according to claim 1, wherein only either the first ram device or the second ram device is guided in a linear guide which extends parallel with the pressing direction.

8. The C-frame press according to claim 1, wherein the first ram device is guided in a linear guide which extends parallel with the pressing direction, and wherein the second ram device is guided by means of at least one lever element which extends perpendicularly to the pressing direction.

9. The C-frame press according to claim 1, wherein the second ram device is guided in a linear guide which extends parallel with the pressing direction, and wherein the first ram device is guided by means of at least one lever element which extends perpendicularly to the pressing direction.

10. The C-frame press according to claim 1, wherein the tension column and the pressure column are supported on the floor by means of a stand device.

11. The C-frame press according to claim 1, wherein the pressure column is connected to the first bending bar and to the second bending bar by means of a fixed bearing, which transmits at least a torque which acts about an axis which extends perpendicularly to the frame plane and a force which acts parallel with the frame plane and perpendicularly to the pressing direction.

12. The C-frame press according to claim 1, wherein only either the first or the second ram device has at least one drive device, and wherein the correspondingly other one of the first and second ram device is constructed as a passive ram which is guided in the respective linear guide which extends parallel with the pressing direction and which is supported on the press frame by means of a pressure bar via a bearing which is torque-free about an axis which extends perpendicularly to the frame plane.

13. The C-frame press according to claim 1, wherein both the first ram device and the second ram device have at least one drive device.

14. The C-frame press according to claim 1, wherein at least one of the first ram device and the second ram device has at least two drive devices which are articulated to a ram of the respective ram device so as to be adjustable separately from each other and so as to be offset perpendicularly to the pressing direction.

15. The C-frame press according to claim 1, wherein at least one of the first ram device and the second ram device has a drive device which has two knee levers which are connected in the same direction and which are articulated to a ram of the respective ram device in a manner offset relative to the pressing direction.

16. The C-frame press according to claim 15, wherein at least one of the two knee levers which are connected to each other in the same direction is fitted to the press frame so as to be adjustable in a direction parallel with the pressing direction.

17. The C-frame press according to claim 16, wherein the adjustable fitting to the press frame is provided by means of an eccentric.

18. The C-frame press according to claim 1, wherein at least one of the first ram device and second ram device has an inclination sensor device which detects an inclination of a ram of the respective ram device relative to the tension column.

19. The C-frame press according to claim 18, wherein the inclination sensor device is formed by at least two spacing sensors which are arranged on the respective ram in a state offset parallel with the pressing direction and which each measure a spacing between the ram and the respective linear guide perpendicularly to the pressing direction.

20. The C-frame press according to claim 1, wherein the inclination sensor device is formed by at least two spacing sensors which are arranged on the respective ram in a state offset perpendicularly to the pressing direction and which each measure a spacing between the ram and a reference bar parallel with the pressing direction, wherein the reference bar extends perpendicularly to the pressing direction from the tension column.

21. The C-frame press according to claim 1, wherein the at least one drive device has a ram, and wherein there is constructed in a longitudinally adjustable manner a lever element which is articulated to the ram in order to be adapted to an installation height of a tool which is arranged on the ram.

22. The C-frame press according to claim 1, wherein the at least one drive device has a ram and at least one drive unit which directly drives the ram.

23. The C-frame press according to claim 1, wherein the at least one drive device has a ram and at least one drive unit which drives the ram via at least one knee lever, wherein a force-displacement-path of the at least one knee lever can be adjusted via an adjustment device.

24. The C-frame press according to claim 1, wherein the first ram device is supported on the first bending bar by means of a bearing which is torque-free about an axis which extends perpendicularly to the frame plane, and wherein the second ram device is supported on the second bending bar by means of a bearing which is torque-free about an axis which extends perpendicularly to the frame plane.

25. The C-frame press according to claim 8, wherein the first ram device has the at least one drive device.

26. The C-frame press according to claim 9, wherein the second ram device has the at least one drive device.

27. The C-frame press according to claim 22, wherein the drive unit is a hydraulic cylinder or a servo-spindle.

28. A C-frame press having a press frame, a first ram device and a second ram device which is opposite the first ram device, wherein at least one of the first ram device and second ram device has at least one drive device and can be moved relative to the other ram device in a pressing direction, wherein the press frame has a first bending bar and a second bending bar which are connected to each other by means of a tension column and a pressure column and which define with the tension column and pressure column a frame plane which extends parallel with the pressing direction, wherein the tension column is connected to each of the first bending bar and the second bending bar by means of a bearing which is torque-free about an axis which extends perpendicularly to the frame plane, wherein the first ram device and the second ram device are each supported on the press frame by means of a bearing which is torque-free about an axis which extends perpendicularly to the frame plane, and wherein the first ram device is guided in a linear guide which extends parallel with the pressing direction and wherein the second ram device is guided in a linear guide which extends parallel with the pressing direction.
